(19) United States
(12) Patent Application Publication
(10) Pub. No.: US 2022/0181642 A1
(43) Pub. Date: Jun. 9, 2022

(54) CATALYST COMPLEX FOR FUEL CELLS AND METHOD FOR MANUFACTURING THE SAME

(71) Applicants: Hyundai Motor Company, Seoul (KR); Kia Corporation, Seoul (KR); Korea Advanced Institute of Science and Technology, Daejeon (KR)

(72) Inventors: Dae Yong Son, Seoul (KR); Jung Han Yu, Yongin (KR); Byoung Su Kim, Yongin (KR); Hyun Joo Lee, Daejeon (KR); Hee Eun Kim, Daejeon (KR)

(21) Appl. No.: 17/398,564

(22) Filed: Aug. 10, 2021

(30) Foreign Application Priority Data
Dec. 3, 2020 (KR) 10-2020-0167162

(51) Int. Cl. H01M 4/90; H01M 4/88

(52) U.S. Cl. CPC H01M 4/9058; H01M 4/8825; H01M 4/9025; H01M 4/9083

(57) ABSTRACT

Disclosed are a catalyst complex which may suppress cell voltage reversal in a fuel cell and a method for manufacturing the same. The catalyst complex includes a support, a first catalytic active material supported on the support and comprising a platinum component including one or more selected from the group consisting of platinum and a platinum alloy, and a second catalytic active material supported on the support and comprising one or more selected from a noble metal other than platinum and an oxide thereof, and the support includes functional groups including oxygen.

### CROSS-REFERENCE TO RELATED APPLICATION

This application claims under 35 U.S.C. § 119(a) the benefit of priority to Korean Patent Application No. 10-2020-0167162 filed on Dec. 3, 2020, the entire contents of which are incorporated herein by reference.

### TECHNICAL FIELD

The present invention relates to a catalyst complex which may suppress occurrence of problems due to cell voltage reversal and a method for manufacturing the same.

### BACKGROUND

Fuel cells for vehicles need to exhibit high output performance of tens of kW or greater under various driving conditions, and must thus be operated within a wide current density range.

A membrane-electrode assembly (MEA) is located at the innermost position of the configuration of the unit cell of a fuel cell stack. The MEA includes a cathode, an anode, and an electrolyte membrane located between the cathode and the anode so as to transport protons between the two electrodes.

Gas diffusion layers (GDLs) and gaskets are stacked on the outer surfaces of the cathode and the anode. Separators (or bipolar plates) configured to provide flow fields, in which reactant gases, cooling water and water, produced due to reaction, flow, are provided outside the GDLs.

Electrochemical reactions occurring in the fuel cell are as follows. Hydrogen supplied to the anode of the fuel cell, which is an oxidizing electrode, is separated into protons and electrons. The protons and the electrons are moved to the cathode, which is a reducing electrode, through the electrolyte membrane and an external circuit, respectively. In the cathode, the protons and the electrons react with oxygen molecules, thereby producing electricity and heat and simultaneously producing water as a by-product.

When a proper amount of water is present in the fuel cell, water properly serves to maintain humidification of the MEA, but, when an excessive amount of water is present in the fuel cell, flooding occurs at a high current density. The flood water disturbs supply of reactant gases to the inside of the fuel cell.

When the amount of hydrogen, serving as fuel, in the anode is insufficient due to water flooding in the fuel cell, ice formation in winter, abnormality of a hydrogen supply apparatus, etc., cell voltage reversal occurs. This cell voltage reversal has a fatal effect on the performance of the fuel cell and thus greatly reduces cell voltage.

Specifically, when the amount of hydrogen gas in the anode is insufficient, anode voltage V_{anode} is increased. When the anode voltage V_{anode} is continuously increased, the anode voltage V_{anode} becomes greater than cathode voltage V_{cathode}, and thus, the fuel cell reaches a cell voltage reversal state in which cell voltage V_{cell} is lower than 0 (V_{cell}=V_{cathode}−V_{anode}<0). In the cell voltage reversal state, water electrolysis, which will be described below, occurs.

H₂O→½O₂+2H⁺+2e⁻, E⁰=1.229 V (vs. SHE)

Here, E⁰ is a standard electrode potential, and SHE is a standard hydrogen electrode. However, when the anode voltage V_{anode} is continuously increased thereafter, carbon corrosion, which will be described below, at the anode is accelerated.

C+2H₂O→CO₂+4H⁺+4e⁻, E⁰=0.207 V (vs. SHE)

C+H₂O→CO+2H⁺+2e⁻, E⁰=0.518 V (vs. SHE)

Further, when the cell voltage reversal state persists and thus the cell voltage becomes less than about −2 V, the fuel cell excessively emits heat, and thus, the MEA and the GDLs may be damaged. Further, serious problems, such as formation of pin-holes in the MEA and electrical shorts of the unit cells of the fuel cell, may be caused.

Conventionally, in order to prevent continuation of the cell voltage reversal state, a system for monitoring the supply state of hydrogen using a sensor or the like has been suggested, but this method could not fundamentally solve the above problems.

The above information disclosed in this Background section is only for enhancement of understanding of the background of the invention and therefore it may contain information that does not form the prior art that is already known in this country to a person of ordinary skill in the art.

### SUMMARY

In one preferred aspect, provided are a catalyst which may induce water electrolysis rather than carbon corrosion when cell voltage reversal occurs in a fuel cell and a method for manufacturing the same. In one preferred aspect, provided are a catalyst in which high contents of catalytic active materials are uniformly supported on a support, and a method for manufacturing the same.

Further provided are a catalyst having excellent durability which increases binding force between a support and catalytic active materials so as to maintain activity even under severe conditions, such as cell voltage reversal, and a method for manufacturing the same.

In an aspect, provided is a catalyst for fuel cells including a support, a first catalytic active material supported on the support and including a platinum component comprising one or more selected from the group consisting of platinum and a platinum alloy, and a second catalytic active material supported on the support and including one or more selected from the group consisting of a noble metal other than platinum and an oxide thereof. In particular, the support may include functional groups including oxygen.

The support may include a carbon material including one or more selected from the group consisting of carbon black, Ketjen black, carbon nanotubes, carbon nanofibers, graphite, graphene, and graphene oxide, and the functional groups bonded, or attached to carbon atoms of the carbon material.

The functional groups may include one or more selected from the group consisting of a carboxyl group, an epoxy group, a ketone group, an aldehyde group, an ether group, and a hydroxyl group.

The support may be configured such that a sum of areas of peaks of the support indicating C—O binding energy is equal to or greater than about 35% of a total area of peaks of the support in C1s X-ray photoelectron spectroscopy (XPS).

The support may be configured such that a ratio (D/G) of an intensity of a D-peak to an intensity of G-peak of a Raman spectrum of the support is equal to or greater than about 1.1.

The second catalytic active material may be connected to oxygen contained in the functional groups.

The platinum alloy may be an alloy of platinum and one or more transition metals selected from the group consisting of nickel (Ni), iron (Fe), cobalt (Co), chrome (Cr), manganese (Mn), and tin (Sn).

The second catalytic active material may include one or more selected from the group consisting of iridium (Ir), ruthenium (Ru), iridium oxide (IrOₓ), ruthenium oxide (RuOₓ), titanium oxide (TiOₓ) manganese oxide (MnOₓ), iridium-ruthenium oxide (Ir—RuOₓ), platinum-iridium (Pt—Ir), platinum-iridium oxide (Pt—IrOₓ), iridium-palladium (Ir—Pd), rhodium (Rh), copper (Cu), nickel (Ni), cobalt (Co), and molybdenum (Mo), aluminum (Al).

The first catalytic active material may include platinum, the second catalytic active material may include iridium oxide (IrOₓ), and a weight ratio of platinum to iridium may be about 1:0.5-1.

In an aspect, provided is a method for manufacturing a catalyst for fuel cells. The method may include preparing a solution including a noble metal other than platinum, putting a support on which a platinum component including one or more selected from the group consisting of platinum and a platinum alloy is supported into the solution, loading the noble metal other than platinum on the support, and oxidizing the noble metal other than platinum loaded on the support. In particular, the support may include functional groups including oxygen.

In the solution, the noble metal other than platinum may be present in a form of nanoparticles.

The support may include a carbon material comprising one or more selected from the group consisting of carbon black, Ketjen black, carbon nanotubes, carbon nanofibers, graphite, graphene, and graphene oxide; and the functional groups bonded to carbon atoms of the carbon material.

The functional groups may include one or more selected from the group consisting of a carboxyl group, an epoxy group, a ketone group, an aldehyde group, an ether group, and a hydroxyl group.

The support is configured such that a ratio (D/G) of an intensity of a D-peak to an intensity of G-peak of a Raman spectrum of the support is equal to or greater than about 1.1.

The method may further include adjusting a pH of a product, which is obtained by putting the support on which the platinum component is supported into the solution, to 0.5-3 such that the noble metal other than platinum is loaded on the support, to about 0.5-3 such that the noble metal other than platinum is loaded on the support.

The noble metal other than platinum supported on the support may be oxidized through heat treatment at a temperature of about 250° C. to 350° C. for about 1 hour to 5 hours.

In an aspect, provided is a method for manufacturing a catalyst for fuel cells. The method may include preparing a solution including a noble metal other than platinum, putting a support into the solution, supporting the noble metal other than platinum on the support, preparing a first catalyst by oxidizing the noble metal other than platinum supported on the support, and mixing a second catalyst including at least one of platinum or a platinum alloy with the first catalyst. The support may include functional groups including oxygen.

The functional groups may include one or more selected from the group consisting of a carboxyl group, an epoxy group, a ketone group, an aldehyde group, an ether group, and a hydroxyl group.

The support may be configured such that a ratio (D/G) of an intensity of a D-peak to an intensity of G-peak of a Raman spectrum of the support is equal to or greater than about 1.1.

The noble metal other than platinum loaded on the support may be oxidized through heat treatment at a temperature of about 250° C. to 350° C. for about 1 hour to 5 hours.

Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows an exemplary catalyst for fuel cells according to an exemplary embodiment of the present invention;

FIG. 2A shows an exemplary support on which a first catalytic active material is supported;

FIG. 2B shows an exemplary support on which a first catalytic active material and a second catalytic active material are supported;

FIG. 3 shows an exemplary method for manufacturing a catalyst for fuel cells according to an exemplary embodiment of the present invention;

FIG. 4 is a graph illustrating results of C1s X-ray photoelectron spectroscopy (XPS) analysis of supports according to example and comparative example 2;

FIG. 5 is a graph illustrating results of Raman analysis of catalysts according to example, comparative example 1 and comparative example 2; and

FIG. 6 is a graph illustrating cell voltage reversal retention times of fuel cells including the catalysts according to example, comparative example 1 and comparative example 2.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The above-described objects, other objects, advantages and features of the present invention will become apparent from the descriptions of embodiments given herein below with reference to the accompanying drawings. However, the present invention is not limited to the embodiments disclosed herein and may be implemented in various different forms. The embodiments are provided to make the description of the present invention thorough and to fully convey the scope of the present invention to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus, it will be understood that they are modified by the term “about”, unless stated otherwise. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

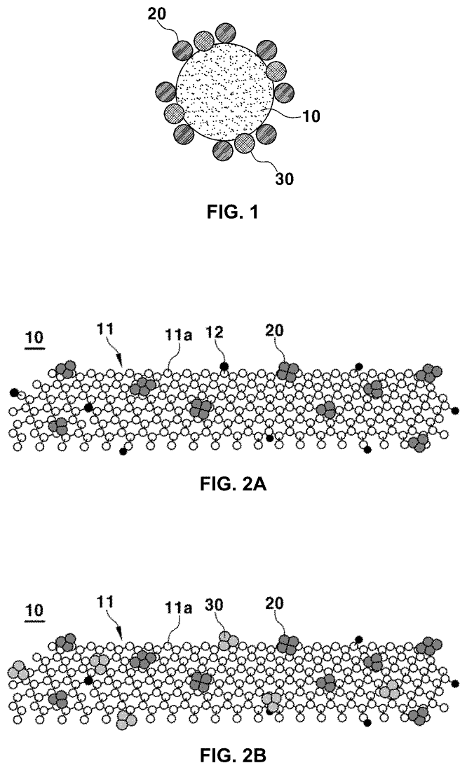

FIG. 1 shows an exemplary catalyst for fuel cells according to an exemplary embodiment of the present invention. For example, the catalyst includes a support 10, a first catalytic active material 20 supported on the support 10 and configured to activate the oxidation reaction of hydrogen and/or the reduction reaction of oxygen, and a second catalytic active material 30 supported on the support 10 and configured to activate water electrolysis when cell voltage reversal occurs.

Conventionally, RuO₂, IrO₂, TiO₂ or the like was added to a fuel cell so that, when cell voltage reversal occurs in the fuel cell, water electrolysis rather than corrosion of carbon dominantly occurs. However, because RuO₂, IrO₂, TiO₂ or the like was simply added to the fuel cell, particles thereof may be agglomerated and thus have a reduced specific surface area, or may be leaked and thus be difficult to induce a desired level of water electrolysis.

The catalyst according to an exemplary embodiment of the present invention is configured such that both the first catalytic active material 20 and the second catalytic active material 30 are supported on the support 10 so as to overcome the above-described problems of the conventional catalyst.

Further, the catalyst according to an exemplary embodiment of the present invention is configured such that functional groups consisting of oxygen is applied to the support 10 and thus increases binding force between the support 10 and the second catalytic active material 30 so as to activate water electrolysis without releasing the second catalytic active material 30 even under severe conditions, such as cell voltage reversal.

FIG. 2A shows an exemplary support 10 on which the first catalytic active material 20 is supported. FIG. 2B shows an exemplary support 10 on which the first catalytic active material 20 and the second catalytic active material 30 are supported.

As shown in FIG. 2A, the support 10 may include a carbon material 11 configured to provide spaces on which the first catalytic active material 20 is supported, and functional groups 12 bonded to carbon atoms 11a of the carbon material 11.

However, the support 10 may be a non-carbon material. For example, the support 10 may be a non-carbon material, such as an oxide, a nitride, a carbide or the like.

The carbon material 11 may include one or more selected from the group consisting of carbon black, Ketjen black, carbon nanotubes, carbon nanofibers, graphite, graphene, and graphene oxide.

The carbon material 11 may be a particulate carbon material, mesoporous carbon material, a hierarchical carbon material or the like.

The functional groups 12, which contain oxygen, may include one or more selected from the group consisting of a carboxyl group, an epoxy group, a ketone group, an aldehyde group, an ether group, and a hydroxyl group.

As shown in FIG. 2B, the second catalytic active material 30 may be supported on the support 10 in the state in which the second catalytic active material 30 is bonded to oxygen atoms contained in the functional groups 12. Because the second catalytic active material 30 is supported on the support 12 through chemical bonding with the function groups 12, the second catalytic active material 30 is not released even under severe conditions, such as cell voltage reversal, and may activate water electrolysis.

The first catalytic active material 20 may include one or more selected from the group consisting of platinum, and a platinum alloy.

The platinum alloy is not limited to a specific alloy and, for example, may include an alloy of platinum and one or more transition metals selected from the group consisting of nickel (Ni), iron (Fe), cobalt (Cr), chrome (Cr), manganese (Mn), and tin (Sn).

The second catalytic active material 30 may include one or more of noble metals other than platinum or an oxide thereof. The second catalytic active material 30 may include one or more selected from the group consisting of iridium (Ir), ruthenium (Ru), iridium oxide (IrOₓ, x being 1 or 2), ruthenium oxide (RuOₓ, x being 1 or 2), titanium oxide (TiOₓ, x being 1 or 2), manganese oxide (MnOₓ), iridium-ruthenium oxide (Ir—RuOₓ), platinum-iridium (Pt—Ir), platinum-iridium oxide (Pt—IrOₓ), iridium-palladium (Ir—Pd), rhodium (Rh), copper (Cu), nickel (Ni), cobalt (Co), molybdenum (Mo), and aluminum (Al).

Particularly, the first catalytic active material 20 may include platinum (Pt), and the second catalytic active material 30 may include iridium oxide (IrOₓ). The weight ratio of platinum (Pt) to iridium (Ir) may be about 1:0.5-1. When the weight ratio of iridium (Ir) is less than about 0.5, the content of iridium (Ir) may be excessively low and thus desired effects may not be acquired, when the weight ratio of iridium (Ir) is greater than about 1, the content of iridium (Ir) may be excessively high and thus water electrolysis may be excessively activated even when cell voltage reversal does not occur.

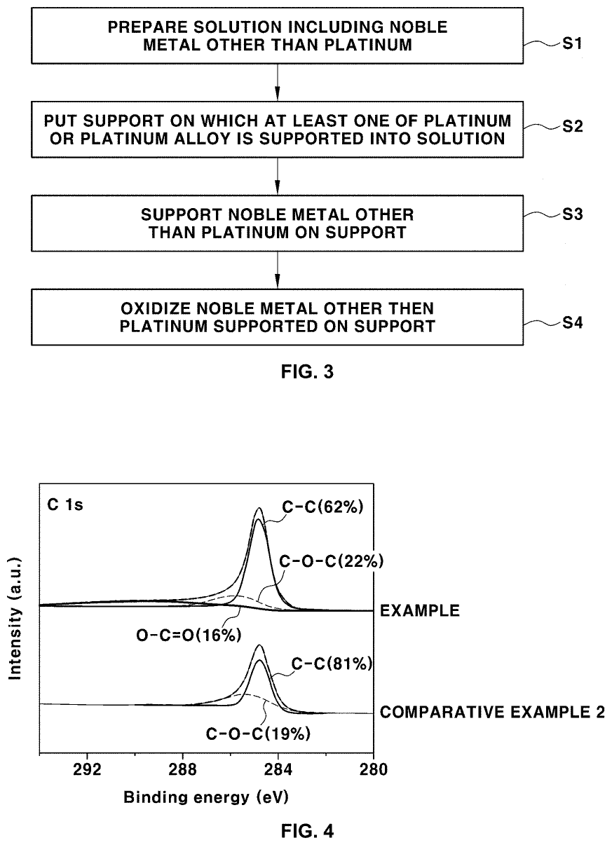

FIG. 3 is a flowchart showing a method for manufacturing a catalyst for fuel cells according to an exemplary embodiment of the present invention. The method includes preparing a solution including a noble metal other than platinum (51), putting a support on which at least one of platinum or a platinum alloy is supported into the solution (S2), loading the noble metal other than platinum on the support (S3), and oxidizing the noble metal other than platinum loaded on the support (S4).

In the solution, the noble metal other than platinum may be present in the form of nanoparticles. Here, the term “nanoparticles” means particles which are nanometers (nm) in diameter.

The solution may be prepared by putting a precursor of the noble metal into a solvent. Hereinafter, a process for preparing the solution will be described in detail.

The solvent is not limited to a specific solvent and, for example, may be ethylene glycol (EG).

After the solvent is alkalified by adding sodium hydroxide (NaOH) thereto, the precursor of the noble metal may be put into the solvent. The precursor of the noble metal is not limited to a specific material and, for example, may be the hydrate of the noble metal. Here, together with the precursor, sodium acetate (CH₃COONa) may be put into the solvent.

After the precursor of the noble metal is put into the solvent, the noble metal other than platinum in the form of nanoparticles may be acquired by heating the solution in the atmosphere of inert gas, such as nitrogen, and then cooling the solution. The heating conditions of the solution are not limited to specific conditions and, for example, the solution may be heated at a temperature of about 100° C. to 200° C. for about 1 hour to 5 hours.

Thereafter, a support on which a first catalytic active material is supported may be put into the solution, and then the noble metal in the form of nanoparticles may be loaded on the support 10 by adjusting the pH of an acquired product to about 0.5-3. Thus, the method may further include adjusting a pH of a product, which is obtained by putting the support on which the platinum component is supported into the solution, to about 0.5-3.

The adjustment of the pH of the product is not limited to a specific method and, for example, at least one of a hydrochloric acid (HCl) solution or an acetic acid (CH₃COOH) solution may be added to the product.

The support on which the first catalytic active material and the noble metal are supported may be produced in the form of powder through filtering and drying.

Thereafter, the noble metal loaded on the support may be oxidized through heat treatment at a temperature of about 250° C. to 350° C. for about 1 hour to 5 hours.

A method for manufacturing a catalyst for fuel cells according to an exemplary embodiment of the present invention may include preparing a solution including a noble metal other than platinum, putting a support into the solution, supporting the noble metal other than platinum on the support, preparing a first catalyst by oxidizing the noble metal other than platinum supported on the support, and mixing a second catalyst including a platinum component including one or more selected from the group consisting of platinum and a platinum alloy with the first catalyst, and the support may include functional groups containing oxygen.

The method according to an exemplary embodiment of the present invention is characterized in that the first catalyst may be manufactured by supporting only the noble metal other than platinum on the support including the functional groups containing oxygen, and then the second catalyst including platinum may be mixed with the first catalyst.

For example, a large amount of the noble metal other than platinum may be supported on the support including the functional groups containing oxygen, and then, the second catalyst including platinum or the platinum alloy may be mixed with the first catalyst, thereby being capable of more variously adjusting the ratio of the noble metal other than platinum to platinum or the platinum alloy.

The second catalyst may be platinum or the platinum alloy itself, or a support on which the platinum or the platinum alloy is supported. The support of the second catalyst may be a carbon-based catalyst or a non-carbon-based catalyst, and be the same as or different from the support of the first catalyst.

Hereinafter, the present invention will be described in more detail through the following examples and test examples. The following examples and test examples serve merely to exemplarily describe the present invention and are not intended to limit the scope of the invention.

### EXAMPLE

The pH of ethylene glycol (EG) serving as a solvent was adjusted to 12 by adding sodium hydroxide (NaOH) thereto. Thereafter, a solution was prepared by putting iridium (III) chloride hydrate (IrCl₃.xH₂O) serving as a noble metal precursor into the solvent. Here, sodium acetate was added. The solution was heated at a temperature of 160° C. for about 3 hours in a nitrogen atmosphere, and was then cooled to room temperature.

An acetic acid solution including a carbon support on which platinum was supported (hereinafter, referred to as Pt/C) was put into the solution. The above-described carbon support including functional groups containing oxygen was used. Here, the pH of the solution was adjusted to about 0.5 by adding a hydrochloric acid (HCl) solution thereto.

An acquired product was agitated for 10 hours or longer at room temperature, filtered, and then dried in an oven heated to a temperature of about 50° C. for about 2 hours, thereby producing powder.

The powder was heat-treated at a temperature of 300° C. for about 2 hours in a furnace in an air atmosphere, thereby finally producing the support on which platinum and iridium oxide were supported.

### Comparative Example 1

A catalyst was manufactured through the same method as that of the above example except that a carbon support including a smaller amount of functional groups containing oxygen than that of the catalyst according to the example was used as a carbon support on which platinum was supported, a hydrochloric acid (HCl) solution including the carbon support other than an acetic acid solution was put into a prepared solution, and the temperature of the furnace was decreased to a temperature of about 200° C.

### Comparative Example 2

A catalyst was manufactured through the same method as that of the above example except that a carbon support including a smaller amount of functional groups containing oxygen than that of the catalyst according to the example was used as a carbon support on which platinum was supported, and a hydrochloric acid (HCl) solution including the carbon support other than an acetic acid solution was put into a prepared solution.

### Test Example 1

C1s X-ray photoelectron spectroscopy (XPS) analysis of the supports used in the example, comparative example 1 and comparative example 2 was performed. The results thereof are shown in FIG. 4. As shown in FIG. 4, in the support according to the example of the present invention, the areas of peaks indicating C—O binding energy, i.e., O—C═O and C—O—C groups, occupied about 38% of the total area of the peaks of the support. On the other hand, in the support according to comparative example 2, the area of a peak indicating C—O binding energy, i.e., a C—O—C group, was very small and thus occupies only about 29% of the total area of the peaks of the support.

### Test Example 2

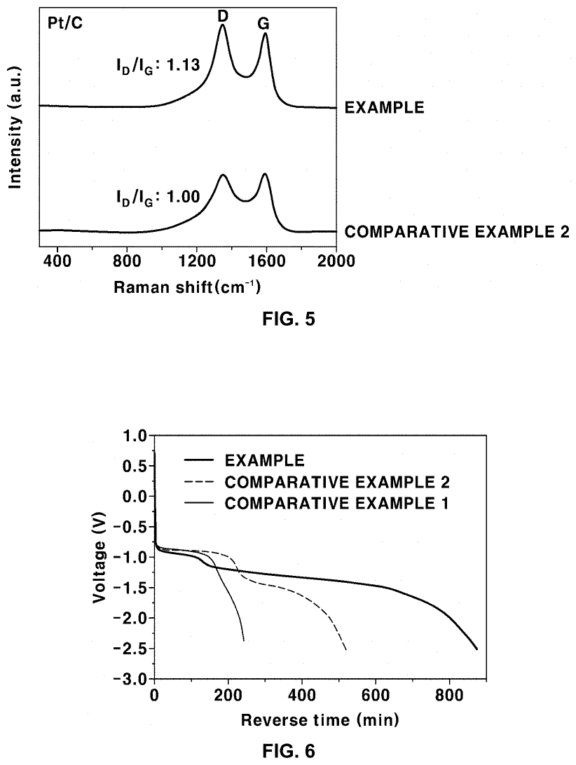

Raman analysis of the catalyst according to the example, comparative example 1 and comparative example 2 was performed. The results thereof are shown in FIG. 5. As shown in FIG. 5, the intensities of the D and G bands of the Raman spectra of the catalysts according to comparative example 1 and comparative example 2 were the same, but the ratio (D/G) of the intensity of the D band to the intensity of the G band of the Raman spectrum of the catalyst according to the example of the present invention was equal to or greater than 1.

Here, the D-peak means a peak observed in the wavelength range of 1300-1400 cm⁻¹, and generally had the maximum absorption wavelength of 1360 cm⁻¹. Further, the G-peak means a peak observed in the wavelength range of 1500-1600 cm⁻¹, and generally has the maximum absorption wavelength of 1580 cm⁻¹. In the Raman spectrum, the D-peak is derived from a non-graphite structure and the G-peak is derived from a graphite structure. Therefore, as the ratio (D/G) of the intensity of the D-peak to the intensity of the G-peak increased, the crystal structure of the carbon material tended to be in disorder.

That is, in the catalyst according to the present invention, because the functional groups containing oxygen are bonded to the support, the crystal structure of carbon collapses a little and thus a higher intensity of the G-peak is observed.

### Test Example 3

The Brunauer-Emmett-Teller specific surface areas of the supports and the catalysts according to the above example and comparative example 2 were measured. The results thereof are set forth in Table 1 below.

TABLE 1

| | BET | | |
|---|---|---|---|
| | specific | Total | Average |
| | surface | pore | pore |
| | area | volume | diameter |
| Classification | [m²/g] | [cm³/g] | [nm] |
| Example-Support | 798.7 | 1.47 | 5.7 |
| Comp. Example | 226.9 | 0.48 | 7.0 |
| 2-Support | | | |
| Example-Catalyst | 419.9 | 0.72 | 6.0 |
| Comp. Example | 127.8 | 0.27 | 7.5 |
| 2-Catalyst | | | |

As shown in Table 1, the specific surface area of the support according to the example was about 3 times the specific surface area of the support according to comparative example 2.

### Test Example 4

Manufacture of Fuel Cell

In order to verify durability of the catalysts according to the example and comparative examples with respect to cell voltage reversal, fuel cells using the catalysts according to the example and comparative examples were manufactured, and then, a durability test with respect to cell voltage reversal was conducted.

(1) Catalyst slurries were produced using the catalysts according to the example and comparative examples, and anodes were formed by spraying the catalyst slurries on a gas diffusion layer (GDL: 39BC, manufactured by SGL carbon in Germany). The weight ratio of a perfluorinated sulfonic acid ionomer dispersion (5 wt % Nafion Dispersion, manufactured by DuPont Co. in USA) to carbon was 0.8, and the loading amounts of respective materials were as follows.

### Comparative Examples 1 and 2

### Example: 0.1 mg_{Pt}/cm²+0.05 mg_{Ir}/cm²

(2) A catalyst slurry was produced using a Pt/C catalyst, and a cathode was formed by spraying the catalyst slurry on a gas diffusion layer (GDL: 39BC, manufactured by SGL carbon in Germany). The weight ratio of a perfluorinated sulfonic acid ionomer dispersion (5 wt % Nafion Dispersion, manufactured by DuPont Co. in USA) to carbon was 0.8, and the loading amount of Pt was 0.4 mg_{Pt}/cm².

(3) The respective anodes and the cathode were located on an electrolyte membrane (NRE211, manufactured by DuPont Co. in USA), and a pressure of 430 psi was applied thereto at a temperature of 135° C. for 135 seconds, thereby forming respective membrane-electrode assemblies (MEAs).

(4) Respective fuel cells were manufactured by sequentially stacking an anode separator formed of titanium (Ti), the respective MEAS, and a cathode separator formed of graphite.

Here, torque applied to eight bolts used to fasten the cells was 50 kgf·cm.

Activation of Fuel Cell

Hydrogen and air were supplied to the anodes and cathodes of the respective fuel cells at a rate of 200 ml/min and a rate of 600 ml/min, respectively, a current density was increased by 100 mA/cm² per second under an open circuit voltage (OCV) state until cell voltage becomes 0.25 V, and, after the cell voltage reaches 0.25 V, such a procedure was repeated until the OCVs and the performances of the respective fuel cells are stabilized. Such a process was performed under conditions of a cell temperature of 65° C. and a relative humidity of 100%.

Durability Test Method with Respect to Cell Voltage Reversal—Measurement of Cell Voltage According to Cell Voltage Reversal Retention Time after Stopping Supply of Hydrogen

Cell voltages of the respective fuel cells were measured through the following method under conditions of a cell temperature of 65° C. and a relative humidity of 100% in order to execute the durability test with respect to cell voltage reversal.

(1) Electric power was applied to the respective fuel cells at a current density of 0.2 A/cm², and hydrogen and air were supplied to the anodes and the cathodes of the respective fuel cells at a stoichiometric ratio of 1.5:2.0.

(2) After 5 minutes from the application of the electric power, supply of hydrogen to the anodes of the respective fuel cells was stopped and then argon (Ar) having the same flow rate as that of hydrogen was supplied thereto.

(3) The time and voltage taken for the cell voltage to become −2.5 V were measured.

(4) The time taken for the cell voltage to be converted from 0 V to −2.5 V was defined as a cell voltage reversal retention time.

The cell voltage reversal retention times of the fuel cells including the catalysts according to the example, comparative example 1 and comparative example 2 are shown in FIG. 6. As shown in FIG. 6, the cell voltage reversal retention time of the fuel cell including the catalyst according to the example was about 3.5 times that of the fuel cell including the catalyst according to comparative example 1 and was about 1.6 times that of the fuel cell including the catalyst according to comparative example 2.

Accordingly, use of the catalyst according to the exemplary embodiment of the present invention may more effectively suppress problems caused by cell voltage reversal occurring in a fuel cell.

According to various exemplary embodiments of the present invention, the catalyst may include water electrolysis rather than carbon corrosion when cell voltage reversal occurs in a fuel cell, which may thus fundamentally solve the problems caused by cell voltage reversal.

Further, in the catalyst according to various exemplary embodiments of the present invention, high contents of catalytic active materials may be uniformly supported on a support.

In addition, the catalyst according to various exemplary embodiments of the present invention may increase binding force between the support and the catalytic active materials, and thus have excellent durability so as to maintain activity even under severe conditions, such as cell voltage reversal.

The invention has been described in detail with reference to various exemplary embodiments of the present invention. However, it will be appreciated by those skilled in the art that changes may be made in these embodiments without departing from the principles and spirit of the invention, the scope of which is defined in the appended claims and their equivalents.

What is claimed is:

1. A catalyst for fuel cells comprising:
a support;
a first catalytic active material supported on the support and comprising a platinum component comprising one or more selected from the group consisting of platinum and a platinum alloy; and
a second catalytic active material supported on the support and comprising one or more selected from a noble metal other than platinum and an oxide thereof,
wherein the support comprises functional groups comprising oxygen.

2. The catalyst for fuel cells of claim 1, wherein the support comprises:
a carbon material comprising at one or more selected from the group consisting of carbon black, Ketjen black, carbon nanotubes, carbon nanofibers, graphite, graphene, and graphene oxide; and
the functional groups bonded to carbon atoms of the carbon material.

3. The catalyst for fuel cells of claim 1, wherein the functional groups comprise one or more selected from the group consisting of a carboxyl group, an epoxy group, a ketone group, an aldehyde group, an ether group, and a hydroxyl group.

4. The catalyst for fuel cells of claim 1, wherein the support is configured such that a sum of areas of peaks of the support indicating C—O binding energy is equal to or greater than about 35% of a total area of peaks of the support in C1s X-ray photoelectron spectroscopy (XPS).

5. The catalyst for fuel cells of claim 1, wherein the support is configured such that a ratio (D/G) of an intensity of a D-peak to an intensity of G-peak of a Raman spectrum of the support is equal to or greater than about 1.1.

6. The catalyst for fuel cells of claim 1, wherein the second catalytic active material is connected to oxygen contained in the functional groups.

7. The catalyst for fuel cells of claim 1, wherein the platinum alloy is an alloy of platinum and comprises one or more transition metals selected from the group consisting of nickel (Ni), iron (Fe), cobalt (Co), chrome (Cr), manganese (Mn), and tin (Sn).

8. The catalyst for fuel cells of claim 1, wherein the second catalytic active material comprises one or more selected from the group consisting of iridium (Ir), ruthenium (Ru), iridium oxide (IrOₓ), ruthenium oxide (RuOₓ), titanium oxide (TiOₓ) manganese oxide (MnOₓ), iridium-ruthenium oxide (Ir—RuOₓ), platinum-iridium (Pt—Ir), platinum-iridium oxide (Pt—IrOₓ), iridium-palladium (Ir—Pd), rhodium (Rh), copper (Cu), nickel (Ni), cobalt (Co), molybdenum (Mo), and aluminum (Al).

9. The catalyst for fuel cells of claim 1, wherein:
the first catalytic active material comprises platinum;
the second catalytic active material comprises iridium oxide (IrOₓ); and
a weight ratio of platinum to iridium is about 1:0.5-1.

10. A method for manufacturing a catalyst for fuel cells, the method comprising:
preparing a solution comprising a noble metal other than platinum;
putting a support on which a platinum component comprising one or more selected from the group consisting of platinum and a platinum alloy is supported into the solution;
loading the noble metal other than platinum on the support; and
oxidizing the noble metal other than platinum loaded on the support,
wherein the support comprises functional groups comprising oxygen.

11. The method of claim 10, wherein, in the solution, the noble metal other than platinum is present in a form of nanoparticles.

12. The method of claim 10, wherein the support comprises:
a carbon material comprising one or more selected from the group consisting of carbon black, Ketjen black, carbon nanotubes, carbon nanofibers, graphite, graphene, and graphene oxide; and
the functional groups bonded to carbon atoms of the carbon material.

13. The method of claim 10, wherein the functional groups comprise one or more selected from the group consisting of a carboxyl group, an epoxy group, a ketone group, an aldehyde group, an ether group, and a hydroxyl group.

14. The method of claim 10, wherein the support is configured such that a ratio (D/G) of an intensity of a D-peak to an intensity of G-peak of a Raman spectrum of the support is equal to or greater than about 1.1.

15. The method of claim 10, wherein the method further comprises adjusting a pH of a product, which is obtained by putting the support on which the platinum component is supported into the solution, to about 0.5-3 such that the noble metal other than platinum is loaded on the support.

16. The method of claim 10, wherein, the noble metal other than platinum loaded on the support is oxidized through heat treatment at a temperature of about 250° C. to 350° C. for about 1 hour to 5 hours.

17. A method for manufacturing a catalyst for fuel cells, the method comprising:
preparing a solution comprising a noble metal other than platinum;
putting a support into the solution;
loading the noble metal other than platinum on the support;
preparing a first catalyst by oxidizing the noble metal other than platinum loaded on the support; and
mixing a second catalyst comprising a platinum component comprising one or more selected from the group consisting of platinum and a platinum alloy with the first catalyst,
wherein the support comprises functional groups comprising oxygen.

18. The method of claim 17, wherein the functional groups comprise one or more selected from the group consisting of a carboxyl group, an epoxy group, a ketone group, an aldehyde group, an ether group, and a hydroxyl group.

19. The method of claim 17, wherein the support is configured such that a ratio (D/G) of an intensity of a D-peak to an intensity of G-peak of a Raman spectrum of the support is equal to or greater than about 1.1.

20. The method of claim 17, wherein, the noble metal other than platinum loaded on the support is oxidized through heat treatment at a temperature of about 250° C. to 350° C. for about 1 hour to 5 hours.
